(19) United States
(12) Patent Application Publication
(10) Pub. No.: US 2005/0124448 A1
(43) Pub. Date: Jun. 9, 2005

(54) Power transmission belt drive system, method of installing same, and kit of components

(76) Inventor: James E. Orr, Posen, MI (US)

Correspondence Address: IRVING M. WEINER;WEINER & BURT, P.C., 635 N. US-23, P.O. BOX 186, HARRISVILLE, MI, 48740, US

(21) Appl. No.: 11/002,914

(22) Filed: Dec. 2, 2004

Related U.S. Application Data
(60) Provisional application No. 60/527,390, filed on Dec. 5, 2003.

(51) Int. Cl. F16H 7/18; F16H 7/24

(52) U.S. Cl. 474/150; 474/140

(57) ABSTRACT

A power transmission belt drive system, a method of installing it, and a kit of components for converting a vehicle from a chain drive system to a belt drive system. The invention provides a belt drive system for motorcycles and bicycles which is virtually indestructible, and maintenance-free and requires no lubrication.

The present application claims priority from and is a continuation-in part of U.S. Provisional Patent Application Ser. No. 60/527,390 filed Dec. 5, 2003, the entire contents of which are incorporated herein by reference thereto.

The present invention relates generally to a power transmission belt drive system, a method of installing same, and a kit of components for converting from a chain drive system to a belt drive system.

In particular, the present invention relates to a stronger, smoother, quieter, and maintenance-free positive belt drive system that will not fail due to the “weak link” of the prior art chain drive systems.

### BACKGROUND OF THE INVENTION

Typically, when a cyclist prepares for a bicycle/cycle trip, part of the gear that is included, in the preparation, is a few chain master links. An experienced rider knows that if the chain drive of the cycle fails, it will be necessary to push the cycle home.

Additionally, as in the case of cycle racing, an experienced rider knows that he will not be able to continue the race if the drive chain of the cycle fails.

As is the case in almost all chain drive systems, the chain is made up of a series of links which are pinned together to form the completed loop of chain. Due to normal machining tolerances and manufacturing procedures, chain links are varied in their integral tolerances and heat treatments. Consequently, the completed chain loop will almost always contain at least one link connection that is weaker than the rest of the completed chain loop. It is that weak link in the chain loop that is the cause for almost all chain failures. Eliminating the weak link is the perplexing problem facing all users of chain driven systems. Ideally, having a drive system which does not contain a weak link but has continuity in its inherent manufacturing tolerances and procedures would be beneficial to all cyclists.

In addition, having a complete loop drive system that is stronger than a chain would offer a significant benefit to the cyclist.

Currently, nearly all pedal (rider) driven bicycles and BMX/Motorcross Cycles and ATV's utilize a chain which connects the front driver sprocket to the rear wheel driven sprocket. As with most chain drive systems, the chain has a tendency to stretch and break. Chain failures occur most often under sudden load and continued excessive load, thereby causing the weakest link in the chain to fatigue and eventually fail.

The prior, but not necessarily relevant, art is exemplified by the following United States patents.

Riccitelli U.S. Pat. No. 4,585,087, entitled “MOTORCYCLE HAVING BELT DRIVE CONVERSION”, discloses a motorcycle converted from a chain to a belt drive which has a cogged drive pulley and a cogged clutch drum drivingly connected to each other by a cogged drive belt.

Leonard U.S. Pat. No. 4,816,008, entitled “VARIABLE-RATIO TRANSMISSIONS SEPARATELY AND IN BICYCLES”, discloses a drive mechanism, particularly for use with a bicycle, of the type having variable diameter drive and driven members connected by an endless belt which engages adjustable segments on the members.

Orr U.S. Pat. No. 4,842,569, entitled “BICYCLE TRANSMISSION HAVING INFINITELY VARIABLE DRIVE RATIO”, discloses a torque transmission apparatus having an infinitely variable gear ratio particularly suited for use as a bicycle transmission.

Leonard U.S. Pat. No. 4,973,289, entitled “VARIABLE-RATIO TRANSMISSIONS, SEPARATELY AND IN BICYCLES”, discloses a drive mechanism, particularly for use with a bicycle, of the type having variable diameter drive and driven members connected by an endless belt which engages adjustable segments on the members.

Warner U.S. Pat. No. 5,938,551, entitled “VARIABLE TENSION PULLEY SYSTEM”, discloses a variable tension pulley system including a drive pulley, a slave pulley, a belt interconnecting the drive pulley and slave, a tensioner assembly positioned between the drive pulley and the slave pulley and in engagement with the belt.

It is a desideratum of the present invention to avoid the animadversions of the above-described prior art techniques, devices and systems.

### SUMMARY OF THE INVENTION

The present invention provides a power transmission belt drive system, comprising, in combination: a vehicle having a vehicle frame member; a drive sprocket disposed on a first side of said vehicle frame member; a driven sprocket disposed on a second side of said vehicle frame member, wherein said second side is opposite to said first side; a drive belt for disposal around said drive sprocket and said driven sprocket; and access/connection means cooperating with said vehicle frame member for facilitating placement of said drive belt through said vehicle frame member and around said drive sprocket and said driven sprocket

The present invention also provides a method of installing a power transmission belt drive system, comprising the steps of: removing a predetermined portion from a frame member of a vehicle; inserting a drive belt through the space provided by removing said portion of said frame member; placing said drive belt around a drive sprocket on one side of said frame member, and around a driven sprocket located on the opposite side of said frame member; and securing together said frame member in the area where said predetermined portion has been removed by means of a compression clamp device.

The present invention further provides a kit of components for converting a vehicle from a chain drive system to a belt drive system, said kit of components comprising: a drive sprocket; a driven sprocket; a timing belt; and a compression clamp.

It is a primary object of the present invention to provide a unique timing belt drive system which can be utilized on virtually all pedal (rider) driven bicycles and nearly all motor-powered BMX/Motorcross Cycles and virtually all motored-powered ATV's.

A further object of the present invention is to provide the unique system mentioned hereinabove, wherein the drive system utilizes a timing belt/sprocket combination that virtually eliminates the weakest link of a similar chain drive system.

Another object of the present invention is to provide the invention as described hereinabove, which can be retrofitted to, but is not limited to, nearly every chain-driven bicycle and motorcross cycle and ATV, and is easily installed by the user.

Yet another object of the present invention is to provide the present invention as described hereinabove, wherein there is provided a closed loop method of the belt drive system comprising a complete loop timing belt, a front driver sprocket, and a rear wheel axle-driven sprocket.

An additional object of the present invention is to provide the invention as described hereinabove, which in the case of pedal bicycles, the timing belt can be installed after the frame support bracket has been installed.

Another object of the present invention is to provide a method of delivering power to the rear wheel of a vehicle which provides the user with a timing belt drive system that is virtually indestructible.

A further object of the present invention is to provide a timing belt drive system that does not require lubrication of any type.

Yet a further object of the present invention is to provide the invention as described hereinabove, wherein the timing belt drive system will not corrode, rot, fracture, or break when exposed to rain, dirt, stones, etc.

Another object of the present invention is to provide a kit of components for converting from a chain drive system to a belt drive system in accordance with the present invention.

The present invention possesses many other advantages and features which will become more apparent to those persons skilled in this particular area of technology and to other persons after having been exposed to the detailed description of the preferred embodiment of the present invention as set forth hereinbelow in conjunction with the accompanying drawings.

### BRIEF DESCRIPTION OF THE DRAWINGS

FIG. 1 is an elevation side view of a preferred embodiment of the present invention.

FIG. 2 is a top view of the FIG. 1 embodiment.

FIG. 3 is an elevational view of some components of the present invention taken along the line 3-3 in FIG. 1, but shown on a magnified scale.

FIG. 4 is a kit of components in accordance with one or more embodiments of the present invention.

### DETAILED DESCRIPTION OF THE INVENTION

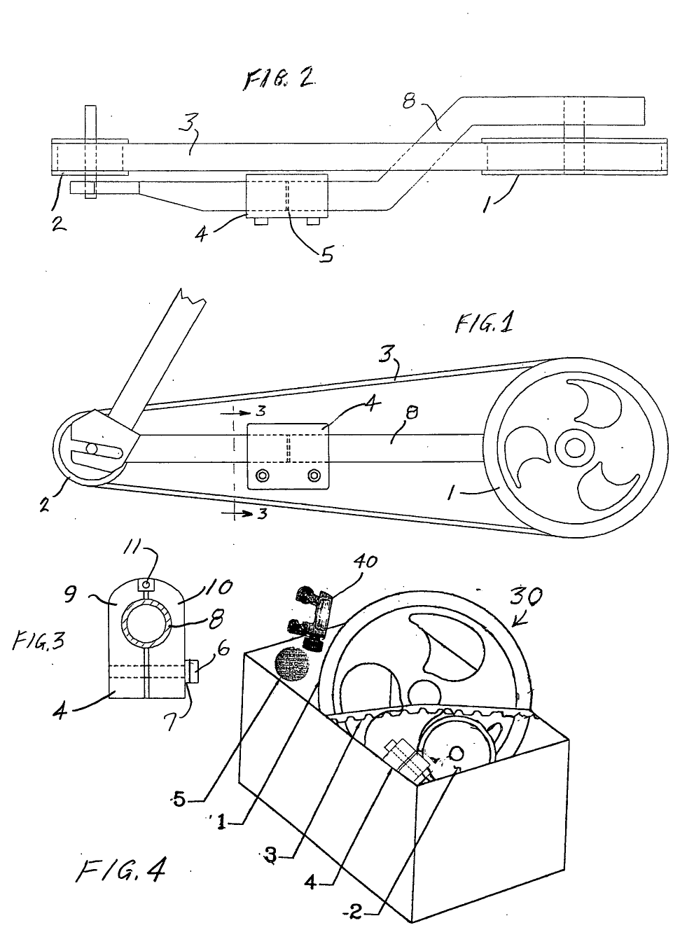

With reference to FIGS. 1, 2, and 3, there is shown a timing belt drive system 20 for a pedal bike which was initially designed to be driven by a chain.

Prior to the present invention, the only way to connect the outside drive sprocket 1 with the inside driven sprocket 2 was with a chain which can be separated, looped around the sprockets 1 and 2 and the frame bar 8 collectively.

In accordance with the present invention, to make the conversion from a chain drive system to a belt drive system, a piece of predetermined dimensions is cut out of the cycle frame 8. Preferably, but not necessarily, the piece cut from the cycle frame 8 is approximately ⅜ of an inch. Through the opening created by cutting out the piece from the cycle frame 8, the timing belt 3 can be inserted and placed around the front sprocket 1 and rear sprocket 2.

One of the key components of the present invention is the novel compression clamp 4 which encircles the cycle frame 8 where it has been cut. After the timing belt 3 has been placed around the front and rear sprockets 1 and 2, respectively, a frame spacer 5 is positioned where the piece was cut or removed from the cycle frame 8. Preferably, but not necessarily, the frame spacer 5 may be fabricated from any suitable material, such as metals or non-metals, but preferably from brass.

The compression clamp 4 includes a pair of main portions 9 and 10 hinged together by a hinge pin 11. The bottom portions 12 and 13 of the compression clamp 4 are held together by way of cap screws 6 and lock washers 7. Preferably, but not necessarily, the compression clamp 4 may include two halves 9 and 10 of light-weight metal which are hinged together by means of the hinge pin 11, and the compression clamp 4 may be secured to the parent material of the frame 8 with two socket-head cap screws 6 and lock washers 7.

Optionally, the conversion kit of components 30 is supplied with a means, such as a tube-cuter 40, for making the frame cutout by the user. The belt 3 is then inserted through the opening made in the frame cutout. In a preferred embodiment, the frame spacer 5 is derived from the previous cut-out of parent frame material, is then installed before attaching the compression clamp 4 which serves as a frame support bracket.

It should be noted that the belt system is of lighter weight than the chain system it replaces.

With reference to FIG. 4, there is shown a kit of components 30 for making the conversion from chain drive to belt drive. The kit 30 may include the front sprocket 1, the rear sprocket 2, the timing belt 3, the compression clamp 4, and the frame spacer 5. Optionally, there may be supplied a means, such as the tube cutter 40, for making the frame cutout.

Preferably, but not necessarily, the timing belt 3 may be 16 mm wide and have a pitch of 10 mm.

The compression clamp 4 joint, when applied correctly, is over 140% stronger than the parent cycle frame 8 from which the cutout is made.

Although the preferred embodiment of the invention as described hereinabove relates to the conversion of any type of existing chain drive vehicle where the chain is required because the driver and driven sprockets are on opposite sides of the frame structure, to a timing belt drive system, the present invention also applies to MX motorcycles and ATV quadrunners.

It should be noted that motorcycles, having both motor/transmission pulley and rear wheel pulley on the inside of its frame, are quite adaptable for belt drives. However, the present invention focuses on a belt drive conversion system where the front drive (pedal) sprocket 1 is on the outside of the frame 8 and the rear wheel driven sprocket 2 is on the inside of the frame 8. Prior to the advent of the present invention, the only way to connect the outside drive sprocket 1 with the inside driven sprocket 2 was with a chain which can be separated and looped around the sprockets 1 and 2 and the frame bar 8 collectively.

In contrast, the present invention relates to applying a closed-loop belt 3 through a bike frame 8 for connection to the driver/driven sprockets 1 and 2.

There has been illustrated in the accompanying drawings and described hereinbaove only one unique and novel preferred embodiment of the present invention which can be constructed in many different configurations, arrangements of components, sizes, and shapes.

It should be understood that many changes, modifications, variations, and other uses and applications will become apparent to those persons skilled in this particular area of technology and to other persons after having been exposed to the present patent specification and the accompanying patent drawings.

Any and all such changes, modifications, variations and other uses and applications which do not depart from the spirit and scope of the present invention are therefore covered by and embraced within the present invention and the patent claims set forth hereinbelow.

1. A power transmission belt drive system, comprising, in combination:
a vehicle having a vehicle frame member;
a drive sprocket disposed on a first side of said vehicle frame member;
a driven sprocket disposed on a second side of said vehicle frame member, wherein said second side is opposite to said first side;
a drive belt for disposal around said drive sprocket and said driven sprocket; and
access/connection means cooperating with said vehicle frame member for facilitating placement of said drive belt through said vehicle frame member and around said drive sprocket and said driven sprocket.

2. A power transmission belt drive system according to claim 1, wherein:
said access/connection means includes a compression clamp.

3. A power transmission belt drive system according to claim 1, wherein:
said access/connection means includes a predetermined opening which is provided by removing from said vehicle frame member a predetermined portion thereof to permit the insertion therethrough of said drive belt, and wherein said predetermined opening is filled by a frame spacer.

4. A power transmission belt drive system according to claim 2, wherein:
said access/connection means includes a predetermined opening which is provided by removing from said vehicle frame member a predetermined portion thereof to permit the insertion therethrough of said drive belt, and wherein said predetermined opening is filled by a frame spacer

5. A power transmission belt drive system according to claim 2, wherein:
said compression clamp includes two halves of light-weight metal hinged together by means of a hardened hinge pin.

6. A power transmission belt drive system according to claim 4, wherein:
said compression clamp includes a two halves of light-weight metal hinged together by means of a hardened hinge pin.

7. A power transmission belt drive system according to claim 2, wherein:
said compression clamp is provided with body portions which are held together by way of suitable fastening means.

8. A power transmission belt drive system according to claim 4, wherein:
said compression clamp is provided with body portions which are held together by way of suitable fastening means.

9. A power transmission belt drive system according to claim 3, wherein: said frame spacer is derived from said predetermined portion of said vehicle frame.

10. A power transmission belt drive system according to claim 4, wherein: said frame spacer is derived from said predetermined portion of said vehicle frame

11. A power transmission belt drive system according to claim 6, wherein: said frame spacer is derived from said predetermined portion of said vehicle frame

12. A power transmission belt drive system according to claim 8, wherein:
said frame spacer is derived from said predetermined portion of said vehicle frame

13. A method of installing a power transmission belt drive system, comprising the steps of:
removing a predetermined portion from a frame member of a vehicle;
inserting a drive belt through the space provided by removing said portion of said frame member;
placing said drive belt around a drive sprocket on one side of said frame member, and around a driven sprocket located on the opposite side of said frame member; and
securing said frame member in the area where said predetermined portion has been removed by means of a compression clamp device.

14. A method of installing a power transmission belt drive system according to claim 13, wherein:
prior to securing together said frame member in said area where said predetermined portion has been removed, there is inserted a frame spacer which is derived from said removed predetermined portion of said frame member.

15. A kit of components for converting a vehicle from a chain drive system to a belt drive system, said kit of components comprising:
a drive sprocket;
a driven sprocket;
a timing belt; and
a compression clamp.

16. A kit of components for converting a vehicle from a chain drive system to a belt drive system according to claim 16, wherein:
there is optionally included in said kit of components, a tube cutter for making a cut-out in a frame of said vehicle.

17. A kit of components for converting a vehicle from a chain drive system to a belt drive system according to claim 15, wherein:
there is optionally provided a frame spacer.

18. A kit of components for converting a vehicle from a chain drive system to a belt drive system according to claim 16, wherein:
there is optionally provided a frame spacer.
